(19) United States
(12) Patent Application Publication
(10) Pub. No.: US 2025/0233533 A1
(43) Pub. Date: Jul. 17, 2025

(54) ELECTROSTATIC HOLDING DEVICE

(71) Applicant: KONICA MINOLTA, INC., Tokyo (JP)

(72) Inventors: Tomoyoshi YUKIMOTO, Tokyo (JP); Yuki HIGUCHI, Tokyo (JP); Hiroshi ISOKAWA, Tokyo (JP); Tatsuya FUJISAKI, Tokyo (JP)

(73) Assignee: KONICA MINOLTA, INC., Tokyo (JP)

(21) Appl. No.: 18/979,777

(22) Filed: Dec. 13, 2024

(30) Foreign Application Priority Data
Jan. 11, 2024 (JP) 2024-002219

(51) Int. Cl. H02N 13/00

(52) U.S. Cl. CPC H02N 13/00

(57) ABSTRACT

Disclosed is an electrostatic holding device including: a holder that electrically holds a workpiece by application of a voltage; and a release facilitator that, when the workpiece is released from the holder, facilitates the release of the workpiece from the holder.

### BACKGROUND OF THE INVENTION

### Technical Field

The present invention relates to an electrostatic holding device.

### Description of Related Art

Conventionally, there has been known a suction device that picks up a predetermined workpiece by a suction section, conveys the workpiece, and releases the workpiece at a target position. To be specific, for example, as disclosed in JP 2019-202239A and JP 2002-134601A, there is known a vacuum suction device that generates a negative pressure by sucking air by a suction section and picks up a workpiece by the negative pressure.

However, such a vacuum suction device may absorb not only air but also foreign matter existing around the workpiece, resulting in reduction of the suction force. In addition, when the workpiece is extremely small, it may not be possible to generate a negative pressure sufficient to pick up the workpiece.

Therefore, for example, JP 2009-066739A and JP 2012-018969A each describe an electrostatic holding device that electrostatically holds a workpiece by application of a voltage. According to the configuration, even an extremely small workpiece can be sufficiently picked up.

### SUMMARY OF THE INVENTION

However, when the workpiece is extremely small, the electrostatic holding devices according to JP 2009-066739A and JP 2012-018969A may not be able to release the workpiece due to the Coulombic force caused by residual charges.

The present invention has been made in view of such circumstances. It is an object of the present invention to provide a holder and an electrostatic holding device that are capable of stably releasing a workpiece.

To achieve at least one of the abovementioned objects, electrostatic holding device reflecting one aspect of the present invention comprises: a holder that electrically holds a workpiece by application of a voltage; and a release facilitator that, when the workpiece is released from the holder, facilitates the release of the workpiece from the holder.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention, wherein:

FIG. 1 is a schematic diagram illustrating a movement of an electrostatic holding device picking up a workpiece at a first position and releasing the workpiece at a second position;

FIG. 2 is a block diagram illustrating an electrostatic holding device according to a first embodiment;

FIG. 3A is an enlarged schematic diagram illustrating a holder according to the first embodiment;

FIG. 3B is an enlarged schematic diagram illustrating the holder according to the first embodiment at a time of release;

FIG. 4A is an enlarged schematic diagram illustrating a modification example of the holder according to the first embodiment;

FIG. 4B is an enlarged schematic diagram illustrating a modification example of the holder according to the first embodiment;

FIG. 5 is a block diagram illustrating an electrostatic holding device according to a second embodiment;

FIG. 6 is an enlarged schematic diagram illustrating a holder according to the second embodiment;

FIG. 7A is an enlarged schematic diagram illustrating a modification example of the holder;

FIG. 7B is an enlarged schematic diagram illustrating a modification example of the holder; and

FIG. 8 is an enlarged schematic diagram illustrating another configuration of a release table.

### DETAILED DESCRIPTION

Hereinafter, an electrostatic holding device according to one or more embodiments of the present invention will be described with reference to the drawings.

However, the scope of the present invention is not limited to the disclosed embodiments. In the following description, components having the same functions and configurations are denoted by the same reference numerals, and a description thereof may be omitted.

### [Overall Configuration of Electrostatic Holding Device]

### First Embodiment

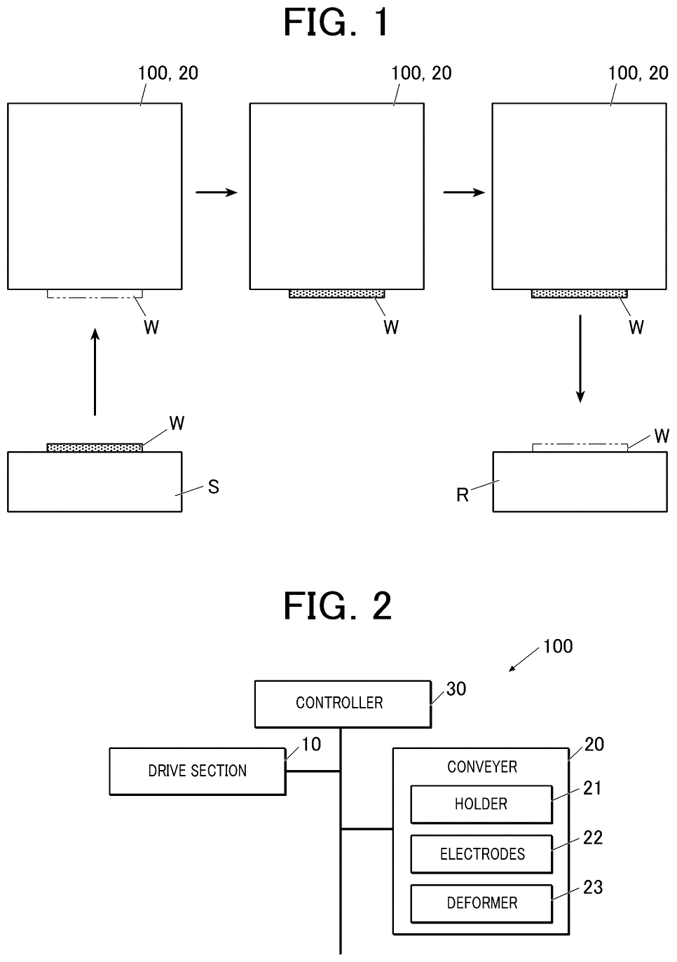

FIG. 1 is a schematic diagram illustrating an electrostatic holding device 100 according to a first embodiment of the present invention. FIG. 2 is a block diagram illustrating the electrostatic holding device 100. As illustrated in FIG. 2, the electrostatic holding device 100 includes a drive section 10, a conveyer 20, and a controller (hardware processor) 30. The electrostatic holding device 100 mainly conveys a workpiece W placed on a placement table S, which is a first position, to a release table R, which is a second position.

In the present embodiment, it is sufficient that the placement table S and the release table R have an area larger than the area of the workpiece W and have a strength that allows the workpiece W to be released. Therefore, the configurations of the placement table S and the release table R are not particularly limited.

### Workpiece

The workpiece W is an object to be adsorbed that is conveyed by the conveyer 20. The workpiece W is, for example, an electronic component such as a multilayer ceramic capacitor, an inductor, a thermister, and a module board, or a semi-finished product in the middle of manufacturing the electronic part. The workpiece W has a size of about 4 mm×4 mm. However, the workpiece W is not limited to an electronic component or a semi-finished product. The size of the workpiece W is also not limited.

### Drive Section

The drive section 10 is coupled to the conveyer 20 and drives the conveyer 20. The drive section 10 is, for example, an electromagnetic motor such as a DC motor, a servo motor, a stepping motor, and a linear motor, an ultrasonic motor, or compressed air. In particular, when the drive section 10 is a stepping motor, the amount of operation required according to the size of the workpiece W can be controlled by the number of steps, which is preferable.

### Conveyer

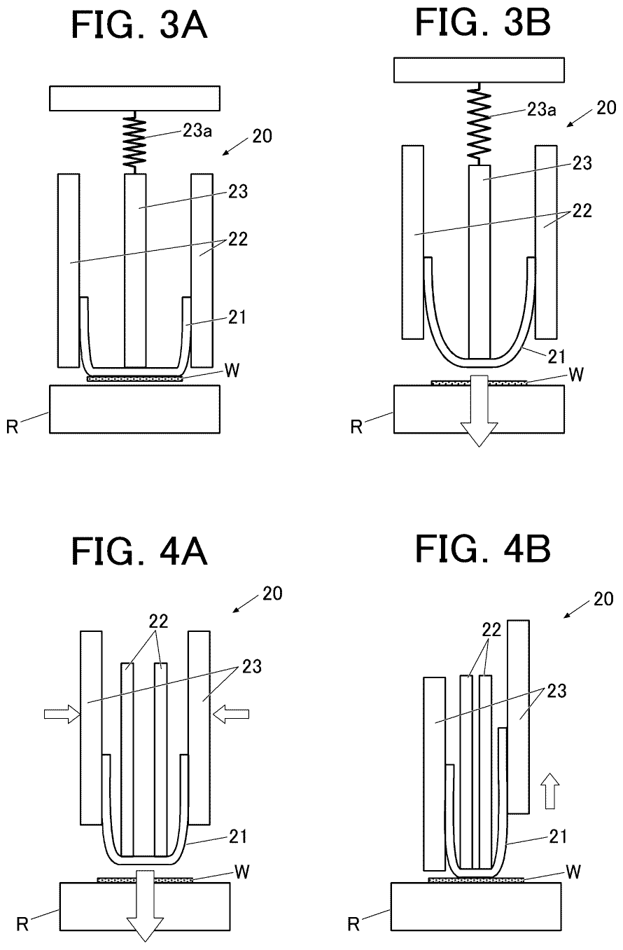

FIGS. 3A and 3B are enlarged schematic views illustrating the conveyer 20. The conveyer 20 includes a holder 21, electrodes 22, and a deformer 23.

### Holder

The holder 21 is a sheet-like member formed of a predetermined dielectric material. The holder 21 is flexible and conductive. When the electrodes 22 apply a voltage, positive charges are generated on the holder 21 and negative charges on a contact surface of the workpiece W with the holder 21. Then, the workpiece W is held to the holder 21 by an electrostatic force (Coulomb force) between the positive and negative charges. Thus, the holder 21 is an electrostatic chuck that holds the workpiece W by the electrostatic force.

### Electrodes

The electrodes 22 are coupled to the holder 21 and applies a voltage to the holder 21 under control of the controller 30. The conveyer 20 includes a first electrode and a second electrode as the electrodes 22. As illustrated in FIG. 3A and FIG. 3B, the first electrode and the second electrode are coupled to the holder 21 with a predetermined gap therebetween.

The first electrode is coupled to an anode of a power source (not illustrated). Therefore, the first electrode is positively charged and functions as a positive electrode. The second electrode is coupled to a cathode of the power source. Therefore, the second electrode is negatively charged and functions as a negative electrode. By using one as a positive electrode and the other as a negative electrode, the potential difference between the first electrode and the second electrode can be increased. As a result, holding force of the holder 21 can be increased.

### Deformer

When the workpiece W is detached from the holder 21, the deformer 23 deforms the holder 21 to reduce a contact area with the workpiece W. In this way, the deformer 23 functions as a release facilitator that facilitates release of the workpiece W from the holder 21.

To be specific, the deformer 23 is, for example, a plate-shaped rod-like member disposed above the holder 21 as illustrated in FIGS. 3A and 3B, and an upper portion of the deformer 23 is fixed by a spring 23a. As illustrated in 3B, the deformer 23 presses the holder 21 with an urging force of the spring 23a, thereby deforming the holder 21 so as to protrude downward. Due to the deformation, the contact area between the holder 21 and the workpiece W decreases, and releasability of the workpiece W at the holder 21 improves.

The configuration of the deformer 23 is not particularly limited as long as it has a predetermined strength. However, it is preferable that the deformer 23 is made of an insulator in order to reduce the possibility of a short circuit occurring when the deformer 23 comes into contact with the holder 21 to which a voltage is applied.

Furthermore, it is preferable that the deformer 23, which is a rod-like member, be configured to press and deform the holder 21 while applying a twisting motion thereto. With the above configuration, the releasability of the workpiece W can be further improved.

### Controller

Referring back to FIG. 2, the controller 30 controls a holding and conveyance operation of the electrostatic holding device 100. The controller 30 includes a central processing unit (CPU), a random-access memory (RAM), and the like.

In addition, a storage section including a read only memory (ROM) or the like in which, for example, an ink jet recording program and other information are stored is coupled to the controller 30. The holding and conveyance operation of the conveyer 20 is carried out by the CPU reading a program and data stored in the ROM, storing them in the RAM, and executing the program.

### Holding and Conveyance Operation

The holding and conveyance operation performed by the electrostatic holding device 100 will be described. First, the controller 30 drives the drive section 10 to move the holder 21 downward toward the placement table S and bring the holder 21 into contact with a target workpiece W. The controller 30 applies a voltage to the electrodes 22 by driving the power source to cause the holder 21 to attract and hold the workpiece W. The controller 30 moves the holder 21 in the up-down direction and in the front-rear and left-right directions by driving the drive section 10, thereby conveying the workpiece W to the release table R. The controller 30 applies a reverse voltage to the electrodes 22 to release the workpiece W in a state in which the contact area with the workpiece W is reduced by deforming the holder 21 by the deformer 23.

### Effects of First Embodiment

As described above, the electrostatic holding device 100 according to the present embodiment includes the deformer 23 that, as a release facilitator that facilitates the release of the workpiece W from the holder 21, deforms the holder 21 so as to reduce the contact area with the workpiece W. According to the above configuration, when the workpiece W is released, the Coulomb force between the holder 21 and the workpiece W can be reduced. This allows the workpiece W to be released more stably.

### Modification Example of First Embodiment

In the above description, the deformer 23 is a rod-shaped member and the contact area with the workpiece W is reduced by pressing the holder 21 downward, but the present invention is not limited thereto. For example, as illustrated in FIG. 4A, a configuration may be adopted in which the holder 21 is pressed from both sides in the left-right direction by the deformers 23 and 23 coupled to the left-side portion and right-side portion of the holder 21, deforming the holder 21 so as to protrude downward. With the above-described configuration, for example, even when the holder 21 and the workpiece W are made smaller, there is no spatial restriction, durability restriction, or the like.

Furthermore, although the configuration in which the electrodes 22 are coupled to both sides of the holder 21 in the left-right direction is illustrated in FIG. 3A, the present invention is not limited thereto. When the holder 21 is bent, if the electrodes 22 are coupled to the bent portions, dielectric breakdown may occur. Therefore, as illustrated in FIG. 4A, the electrodes 22 may be coupled to positions avoiding the bent portions of the holder 21 to increase the durability of the electrodes 22 against the bending of the holder 21.

Alternatively, as illustrated in FIG. 4B, a configuration may be adopted in which one of the deformers 23 and 23 coupled to the left-side portion and right-side portion of the holder 21 is pulled upward to reduce the contact area between the workpiece W and the holder 21 by the peeling action.

In addition, a configuration may be adopted in which the holder 21 is formed of a member that contracts when a voltage is applied and expands to the original size when the applied voltage is released, so as to be deformed.

### Second Embodiment

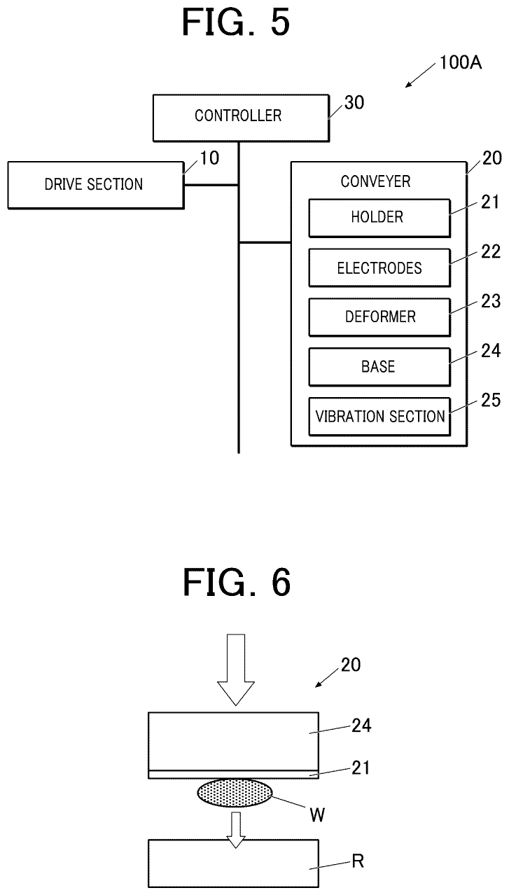

Next, an electrostatic holding device 100A according to a second embodiment will be described with reference to FIGS. 5 and 6. Note that contents that are the same as those of the first embodiment are denoted by the same reference signs, and a detailed description thereof will be omitted. As illustrated in FIG. 6, the electrostatic holding device 100A according to the second embodiment is different from the first embodiment in that the conveyer 20 includes a base 24 and the holder 21 is disposed under the base 24. In addition, a vibration section 25 such as a vibrator or a vibration motor is disposed in the base 24.

When the workpiece W is to be released, the controller 30 causes the vibration section 25 to vibrate the base 24, thereby applying vibration to the workpiece W via the holder 21 to facilitate the release. Thus, in the present embodiment, the vibration section 25 functions as a release facilitator.

In the present embodiment, the controller 30 preferably causes the vibration section 25 to vibrate the holder 21 at a frequency and an amplitude corresponding to the properties of the workpiece W to be conveyed, such as the material, weight, contact area with the holder 21, and shape (position of the center of gravity). For example, when attachment force of the workpiece W is large, it is preferable to vibrate the holder 21 at a higher frequency.

In addition, the controller 30 may cause the vibration section 25 to vibrate the holder 21 so as to have a frequency and an amplitude corresponding to the characteristics of the holding and conveyance operation. For example, when it is desired to make the release time shorter, it is preferable to vibrate the holder 21 with a higher amplitude.

Furthermore, in the present embodiment, it is more preferable that the controller 30 causes the vibration section 25 to vibrate the holder 21 based on the position of the holder 21 and a landing position of the workpiece W. For example, when the holder 21 is vibrated in a shearing direction parallel to a portion of the workpiece W attached to the holder 21 even though it is desired to release the workpiece W to a position directly below the holder 21, the workpiece W is released to a position deviated from the target landing position. Therefore, specifically, it is preferable to vibrate the holder 21 in a direction connecting the position of the holder 21 and the (target) landing position.

### Effects of Second Embodiment

As described above, the electrostatic holding device 100A according to the present embodiment includes the vibration section 25 that, as a release facilitator that facilitates release of the workpiece W from the holder 21, vibrates the holder 21. According to the above configuration, the workpiece W can be released stably.

### [Other Configurations]

Although specific descriptions have been given above based on the embodiments according to the present invention, the present invention is not limited to the above-described embodiments. Various modifications are possible within the scope of the invention described in the claims and their equivalents.

For example, in the above description, a case where the electrostatic holding device 100 according to the first embodiment and the electrostatic holding device 100A according to the second embodiment include the release facilitators having different configurations has been exemplified, but the present invention is not limited thereto. That is, for example, the electrostatic holding device 100 may have a configuration in which the holder 21 is deformed while being vibrated by the deformer 23. That is, the electrostatic holding device 100 may have both the configurations of the release facilitator according to the first embodiment and the release facilitator according to the second embodiment.

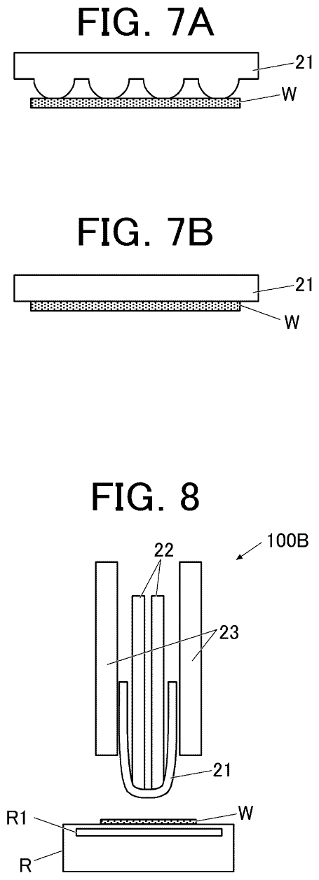

Furthermore, in the above description, the deformer 23 and the vibration section 25 have been exemplified as release facilitators, the present invention is not limited thereto. For example, particles may be provided in the holder 21 as a release facilitator so that a plurality of protruded portions are formed on a contact surface with the workpiece W when no voltage is applied as illustrated in FIG. 7A, and that the contact surface with the workpiece W becomes flat while a voltage is applied as illustrated in FIG. 7B. The particles are, for example, titanium oxide. In the above-described configuration, a contact area between the workpiece W and the holder 21 can be reduced, thus facilitating release of the workpiece W.

Further, in the above description, the configuration of the release table R is not particularly limited, but as illustrated in FIG. 8, the release table R may include an attractor R1 controlled by the controller 30 of the electrostatic holding device 100B.

The attractor R1 is disposed in the vicinity of a placement surface of the workpiece W. Similarly to the holder 21 of the conveyer 20, application of a voltage and application of a reverse voltage to the attractor R1 are controlled by the controller 30. When a voltage is applied, the attractor R1 electrostatically attracts the workpiece W in contact with (placed on) the attractor R1.

In the above-described configuration, the controller 30 synchronizes the application of the reverse voltage (release) to the holder 21 of the conveyer 20 with the application of the voltage to the attractor R1 of the release table R. According to the above-described configuration, attraction force of the attractor R1 of the release table R can be made greater than the holding force of the holder 21 of the conveyer 20, and the releasability of the workpiece W by the conveyer 20 can be further improved.

In addition, it is more preferable that the angle of the holder 21 can be appropriately changed by the controller 30. When the workpieces W having different centers of gravity are released in the same manner, landing positions will vary depending on the centers of gravity of the workpieces W. Therefore, if the controller 30 is configured to appropriately adjust the angle of the holder 21 with respect to the release table R according to the center of gravity of the workpiece W, the landing position of the workpiece W can be controlled.

In addition, in the above description, a configuration in which each component of the electrostatic holding device 100 is controlled by the controller 30 included in the electrostatic holding device 100 has been exemplified, but the present invention is not limited thereto. For example, each component of the electrostatic holding device 100 may be controlled by a device separate from the electrostatic holding device 100.

In the above description, the electrostatic holding device 100 in which the conveyer 20 conveys the workpiece W from the placement table S to the release table R by the drive section 10 has been exemplified, but the present invention is not limited thereto. That is, for example, the electrostatic holding device 100 may be configured such that the holder 21 only moves up and down to pick up and release the workpiece W at the same position.

In the above description, a reverse voltage is applied from the power source to the electrodes 22 when the workpiece W is released, but the present invention is not limited thereto. That is, a configuration may be adopted in which the power source is stopped to stop the application of the voltage to the electrodes 22.

In addition, in the above description, a configuration in which one electrostatic holding device 100 includes one conveyer 20 has been exemplified, but the present invention is not limited thereto. That is, it is a matter of course that one electrostatic holding device 100 may include a plurality of conveyers 20.

Although embodiments of the present invention have been described and shown in detail, the disclosed embodiments are made for purposes of illustration and example only and not limitation. The scope of the present invention should be interpreted by terms of the appended claims.

The entire disclosure of Japanese Patent Application No. 2024-002219 filed on Jan. 11, 2024, is incorporated herein by reference in its entirety.

What is claimed is:

1. An electrostatic holding device comprising:
a holder that electrically holds a workpiece by application of a voltage; and
a release facilitator that, when the workpiece is released from the holder, facilitates the release of the workpiece from the holder.

2. The electrostatic holding device according to claim 1, wherein
a contact portion of the holder with the workpiece is at least partly flexible, and
the release facilitator includes a deformer that deforms the holder so as to reduce an area of the contact portion.

3. The electrostatic holding device according to claim 1, wherein the release facilitator includes a vibration section that vibrates the holder.

4. The electrostatic holding device according to claim 3, wherein the vibration section vibrates the holder in a direction connecting a position of the holder and a landing position of the workpiece.

5. The electrostatic holding device according to claim 1, wherein the release facilitator is configured to form a plurality of protruded portions on a contact surface with the workpiece when a reverse voltage is applied to the holder.

6. The electrostatic holding device according to claim 1, further comprising:
a drive section that conveys the holder from a first position to a second position; and
a hardware processor that, at the first position, causes the holder to electrically hold the workpiece by application of a voltage and, at the second position, causes the holder to release the workpiece from the holder by stopping the application of the voltage or applying a reverse voltage.

7. The electrostatic holding device according to claim 6, further comprising an attractor disposed at the second position that electrically attracts the workpiece by application of a voltage, wherein, when applying the reverse voltage to the holder, the hardware processor applies a voltage to the attractor.

8. The electrostatic holding device according to claim 6, wherein, when the workpiece is released from the holder, the hardware processor adjusts an angle of the holder with respect to the second position in accordance with a center of gravity of the workpiece.
